(19) United States
(12) Patent Application Publication
(10) Pub. No.: US 2011/0100509 A1
(43) Pub. Date: May 5, 2011

(54) Guide device for cutting through dovetail joints

(76) Inventor: Toyohisa Sugita, Tokyo (JP)

(21) Appl. No.: 12/589,926

(22) Filed: Nov. 2, 2009

(51) Int. Cl. B27F 1/08

(52) U.S. Cl. 144/144.51

(57) ABSTRACT

A guide device for cutting a through dovetail joint consisting of a tail board template and a pin board template, the templates being made of a relatively thin material. The tail board template has a series of cutouts in the shape of an isosceles trapezoid provided longitudinally therein, the narrowest portions or tops of the cutouts in parallel alignment with the top edge of the tail board template and the broadest portions or bottoms of the cutouts in alignment below the tops of the cutouts. The pin board template has a main body serving as a base or bottom of the template and a series of fingers in the general shape of an isosceles trapezoid, of generally the same size and shape of the isosceles trapezoidal cutouts in the tail board, protruding from the main body of the pin board template. The isosceles trapezoidal fingers are connected to the main body by relatively short rectangular connecting portions or bridges, forming a series of rectangular areas that are open topped between adjacent fingers. Use of these templates with a router greatly facilitate the accurate cutting of tail boards and pin boards to form a through dovetail joint. There is also a stopper that can be used to with the tail board template for accurately adjusting the workpiece before cutting.

### BACKGROUND OF THE INVENTION

1. Field of the Invention

This invention relates to novel guide device for cutting through dovetail joints with a router or laminate trimmer and more particularly to a dovetail joint guide device or jig by which through dovetail joints can be easily cut with exceptional accuracy in a very short time. The guide device enables hobbyists to produce professional looking dovetail joints without the need for a large number of templates or complicated procedures. The present guide device also allows a number of dovetail joints to be produced continuously so that a number of cabinet or drawer projects, etc. can be easily accomplished on a scale approaching mass production.

2. Description of the Related Art

Dovetail joints are a professional method of producing adjoining and interlocking joints for cabinets, drawers, etc., by which an incredibly strong joint can be produced. The work of forming dovetail joints for drawers, cabinets, etc., has been long been performed in the art of woodworking and is an eye pleasing sign of fine craftsmanship. There are several methods of making dovetail joints, all of them requiring a number of troublesome steps and adjustments that can introduce inaccuracies into the work. These processes make forming a dovetail joint that is square, strong and elegant a daunting task for all but the most experienced wood workers, both hobbyist and professional alike. To simplify this task, a number of inventors have devised a variety of jigs or guide devices for use with a router, etc. For example, there is the very well known and widely used Keller dovetail template system using various templates or gauges, as seen in several US patents including U.S. Pat. Nos. 4,168,730, 5,139,062 and 5,199,477. However, it is somewhat cumbersome to use and difficult to adjust accurately and it seems to be too delicate for rough use in a workshop. Further, the Keller dovetail system requires special dovetail and straight router bits that can only be used with Keller jigs.

For this reason, a number of patents have been granted for improvements on the Keller system. For example, as shown in FIG. 16 one conventional method as described in U.S. Pat. No. 6,305,449 to Stover, requires a positioning apparatus comprised of a guide fence unit with two pivotally secured parallel runner guide bars. The guide fence is comprised of a base plate attached to a vertical guide plate that is in turn affixed to the forward abutting edge of the base plate. A sighting aperture is located at the center of the guide fence unit for visually aligning the workpiece. The base plate has a central cavity along its forward edge and means to lock the guide bars thereto. A number of graduations are provided on the edge of the base plate as well.

In operation, a number of steps are required for creating the dovetail tails or sockets (into which the dovetail pins will ultimately fit) that entail scribing guide lines, adjusting the router to the proper height, aligning the guide fence, locking the guide fence to the guide bars with several friction fittings, affixing an auxiliary strip to the guide fence, sliding the positioning apparatus past the table router to create a guiding profile, aligning the workpiece using the guiding profile, clamping the workpiece to the guide fence, again sliding the positioning apparatus with the first workpiece past the router, and repeating the last three steps. Fabricating the dovetail pins with this apparatus requires even more steps and repetitions. All of these clamping and cutting steps add inaccuracies to the final product and can be cumbersome to carry out repetitively for a series of joints, making the use of this kind of jig somewhat troublesome for the average hobbyist woodworker.

Another conventional method of making dovetail joints, among others, can be seen in U.S. Pat. No. 6,315,017 to Stottman, shown in FIG. 17. Stottman uses a jig comprised of a base board, a clamp board, a backer board and a template board that are secured to each other by a combination of woodscrews, glue, etc., for example. The template board, forming the dovetail template, is secured to the bottom of the base board with the fingers forming the router pattern extending beyond the backer board. The workpiece is inserted into this assembly and is passed over a table mounted router. The assembly is guided over the router bit by a bearing or bushing below the bit, along which the edges of the fingers are guided. In order for a full cut to be made in the workpiece, the backer board must be able to accept a portion of the router bit that passes through the workpiece. However, one of the disadvantages of this method is the need to have several template boards for various sizes of cuts, adding to cost and storage problems. Another problem is the backboard relationship to the cutting of the joint. That is, as noted in the patent, the backboard can be damaged and may need to be replaced periodically, which may also have an effect on the final joint, making this jig also somewhat troublesome.

Further, not only are all of these jigs, including the well known Keller jig, troublesome to adjust for accurate joint cuts, they are expensive to replace if damaged. In other words, most other known dovetail jigs suffer from being very complicated, somewhat difficult to adjust accurately and expensive to use maintain over time. There is also a problem of tailboard length. That is, all of these conventional systems require the tailboard to be clamped vertically to the jig, either above or below the worktable. As will be readily apparent, this requires either a tall worktable or a lot of ceiling space when the workpiece is more than about three or four feet in length. Similarly, when the workpiece is clamped to the jig in this fashion, the whole assembly must be moved, a process sure to add difficulty and inaccuracies to the cutting work.

Finally, most of these previous systems require the use of at least two router bits of different shapes, generally a dovetail and straight bit, to cut the tail and pins of the dovetail joint. This requires readjustment of the router after changing of the bits, frequently resulting in not just frustrations in trying to eliminate inaccuracies, but ruined work pieces as well.

To overcome these problems, the present inventor developed a novel guide device or jig for cutting dovetail joints by which extremely accurate dovetail joints can be easily formed without the need for a variety of templates, troublesome measurements or a number of adjustments. This novel guide device can be used with the tailboard flat on the worktable, so that there is no great limitation on workpiece length. Further, this can be accomplished with only the use of the same router bit, normally a straight cut bit, for both the tail and pin cuts. Finally, by first setting the router bit to cut just to the bottom surface of the tailboard, the same setting can be used to cut the pin board as well.

### SUMMARY OF THE INVENTION

The present invention has been made with a view to solve the problems stated above and its object is to provide a device for cutting dovetail joints and more particularly to a through dovetail joint guide device by which through dovetail joints can be accurately and easily formed.

According to this invention, a guide device or jig for cutting a through dovetail joint is provided which, in one embodiment, includes a rectilinear guide member or template for use in cutting a tail board, hereinafter a tail board template, and another rectilinear guide member or template, for cutting a pin board, hereinafter a pin board template. The tail board template is generally a thin plate or thin plate-like member made of metal or other suitable material, having a series of cutouts or template guides in the shape of an isosceles trapezoid, hereinafter isosceles trapezoidal cutouts, provided longitudinally therein, the narrowest portions or tops of the cutouts in parallel alignment with the top edge of the tail board template and the broadest portions or bottoms of the cutouts in alignment below the tops of the cutouts. The pin board template is also generally a thin plate or thin plate-like member made of metal or other suitable material, having a main body serving as a base or bottom of the template and a series of patterns or fingers in the general shape of an isosceles trapezoid, hereinafter isosceles trapezoidal fingers, of generally the same size and shape of the isosceles trapezoidal cutouts in the tail board, protruding in the same plane from the main body of the pin board template. The isosceles trapezoidal fingers connected to the main body by relatively short rectangular connecting portions or bridges, forming a series of rectangular areas that are open topped between adjacent fingers. An adjustable stopper is also provided for use on the tail board template for setting the depth of the cut in the tail board, i.e. the size of the cut as measured from the joint edge of the workpiece, the stopper also being a thin plate or thin plate-like member made of metal or other suitable material, with a main body serving as a base or bottom of the stopper and a series of patterns or fingers protruding in the same plane from the main body of the stopper and spaced to fit between the trapezoidal cutouts of the tail board template, the stopper being secured in position by normal means such as clamps or, in another modification, by screws, etc. By the use of this stopper, the depth of cut on the tail board can be easily set with no further adjustments necessary, providing, in conjunction with the templates, a fast, accurate and easy means to cut professional looking dovetail joints.

In another embodiment, two threaded posts are attached adjacent to either edge of at the sides of the top of the tail board template in an area above the narrowest portions or tops of the trapezoidal cutouts, and the stopper is provided with two rectangular openings extending parallel and adjacent to either edge near the bottom of the stopper, at a position corresponding to the threaded posts, the rectangular openings fitting over the threaded posts so that the stopper can be fixed to the tail board at an appropriate position.

In a further embodiment, at least two rectangular windows are provided, one on each side of the series of trapezoidal cutouts, an uppermost portion of each rectangular window being in parallel alignment with the broadest portions of the trapezoidal cutouts, the windows being adapted to accept a scrap piece from a workpiece so that the stopper can be adjusted to run up against the bottom edge of the scrap piece and firmly secured to the template 1, as will be described in detail below

In another related embodiment of the invention, both the tail board template and the pin board template comprise two thin plates or thin plate-like members respectively, each member being a mirror image of the other. That is, the tail board template comprises two thin plate-like members with mutually symmetrical quadrilateral apertures or cutouts provided longitudinally therein, wherein the same side of each cutout is not parallel to the opposite side. By flipping one of the guide members over and sliding the quadrilateral cutouts longitudinally over the set of quadrilateral cutouts in the bottom guide member, the size of the resultant cutout can be adjusted while still retaining the relative isosceles trapezoidal shape, as explained in more detail below. Similarly, the pin board template comprises thin plates or thin plate-like members with mutually symmetrical fingers of a generally triangular pattern connected to the main body of the member by thin rectangular bridges. Again, by flipping one of the thin plate-like members over and sliding the fingers over the fingers on the bottom thin plate-like member, the size of the rectangular areas between the fingers and the distances between each finger can be adjusted, so that a generally isosceles trapezoid shape can be formed by the outline of the fingers.

A better understanding of the features and advantages of the present invention will be obtained by reference to the following detailed description of the invention and accompanying drawings which set forth illustrative embodiments in which the principles of the invention are utilized.

### BRIEF DESCRIPTION OF THE DRAWINGS

FIG. 1 is a perspective view of a guide device for cutting a through dovetail joint of the present device.

FIG. 2 is a plan view of a tail board template of the present device.

FIG. 3 is a plan view of a pin board template of the present device.

FIG. 4 is a perspective view of the present device showing the use of the tail board template.

FIG. 5 is a plan view of a stopper of the present device.

FIG. 6 is a perspective view of the present device showing the underside of the tail board template showing one embodiment for using a stopper.

FIG. 7 is a perspective view of the present device showing the use of the movable stopper.

FIG. 8 is a perspective view of the present device showing the use of the pin board template

FIG. 9a and FIG. 9b are explanatory views of a through dovetail joint that can be made using the present invention.

FIG. 10 is a perspective view showing use of a backer board with the pin board template of the present invention.

FIG. 11 is a side view of a rotary bit using a pilot bearing or template guide in use with the present device.

FIG. 12a and FIG. 12b are plan views of another embodiment of the tail board template of the present device.

FIG. 13a and FIG. 13b are plan views of another embodiment of the pin board template of the present device.

FIG. 14 is a perspective view of another embodiment of the invention showing the provision of a rectangular cutout in the tail board template.

FIG. 15a and FIG. 15b are explanatory perspective views showing use of the present device with a table router.

FIG. 16 is a view of a conventional guide device.

FIG. 17 is a view of another conventional guide device

### DESCRIPTION OF THE PREFERRED EMBODIMENTS

Preferred embodiments of a guide device for cutting through dovetail joints according to this invention will be described hereunder with reference to the drawings.

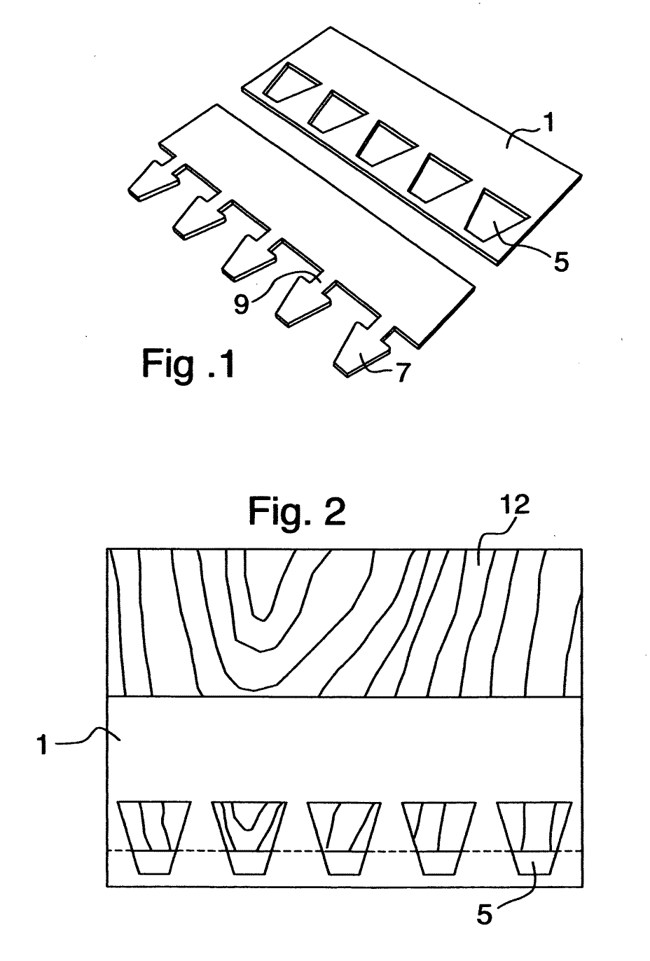

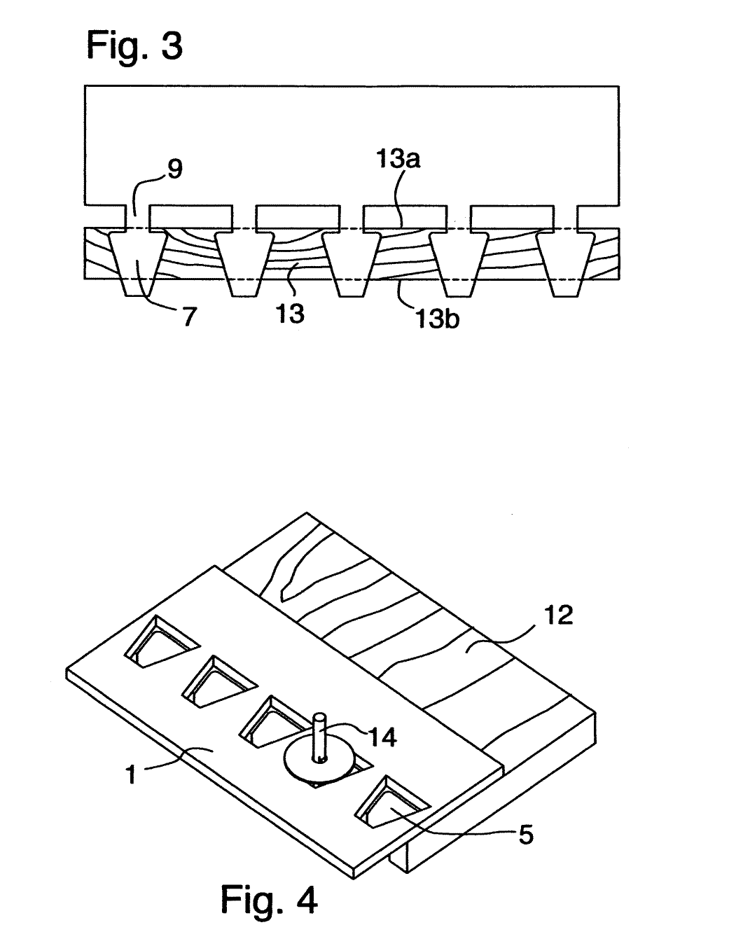

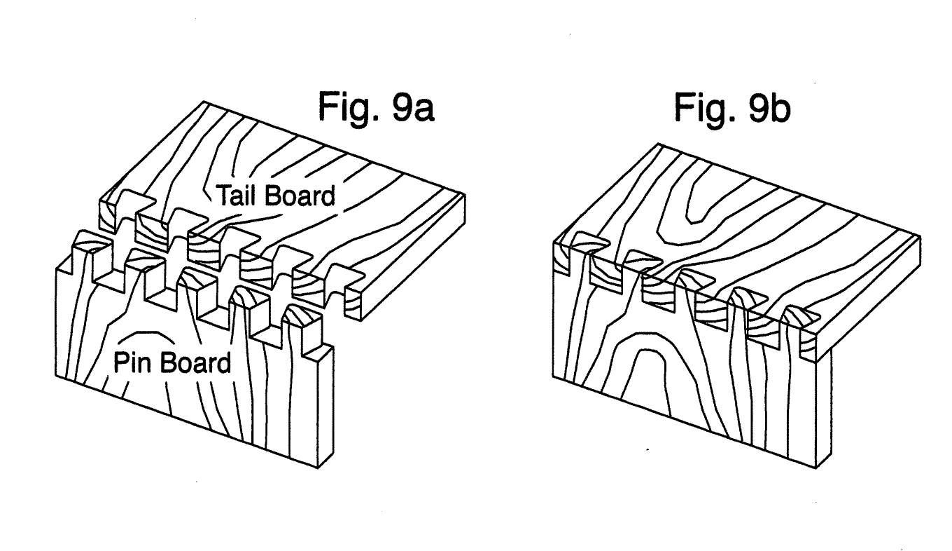

In FIGS. 1 to 3, one embodiment of the device is shown in which 1 denotes a tail board template, 3 denotes a pin board template, 5 a plurality of isosceles trapezoidal cutouts for guiding a router, 7 a plurality of fingers extending by way of bridges 9 from the main body of the pin board template 3 for guiding a router, 11 are rectangular areas formed between adjacent bridges 9 and bottom portions of the fingers 7, and 12 and 13 are work pieces as partially denoted by broken lines in FIGS. 2 and 3, with an inner surface 13a and an outer surface 13b defined in relation to the finished joint as seen in FIG. 9. The shape of the fingers 7 generally correspond to the size and shape of the cutouts 5.

The operation of this embodiment will be described below. First, the operation for cutting the tail board will be explained. As also shown in FIG. 4, the tail board template 1 is placed on the workpiece 12 and clamped thereto using clamps or other known means, so that the cutouts 5 are placed in an appropriate position that corresponds to the depth of cut desired for the tail board, normally the width of the edge of the workpiece 13. As shown in FIG. 4, a router, as represented by router bit 14, to which a known template guide or pilot bearing is attached, is used to cut into the workpiece 12 guided by the cutouts 5, to produce a tail board, that is, one half of a through dovetail joint as seen in FIG. 9a.

Next, the operation for cutting the pin board will be described. As seen in FIG. 3, the pin board template 3 is placed over the edge of a workpiece 13 and clamped thereto as will be explained below, so that the fingers 7 have their broadest portions or bottom edges aligned along the inner edge 13a of the workpiece 13. As shown in FIG. 8, the same router bit 14 with a template guide or pilot bearing still attached, is used to cut into the workpiece 13 guided along the outside edges of the fingers 7 and the rectangular areas 11 to produce pin board, that is, the other half of the through dovetail joint as seen in FIG. 9a.

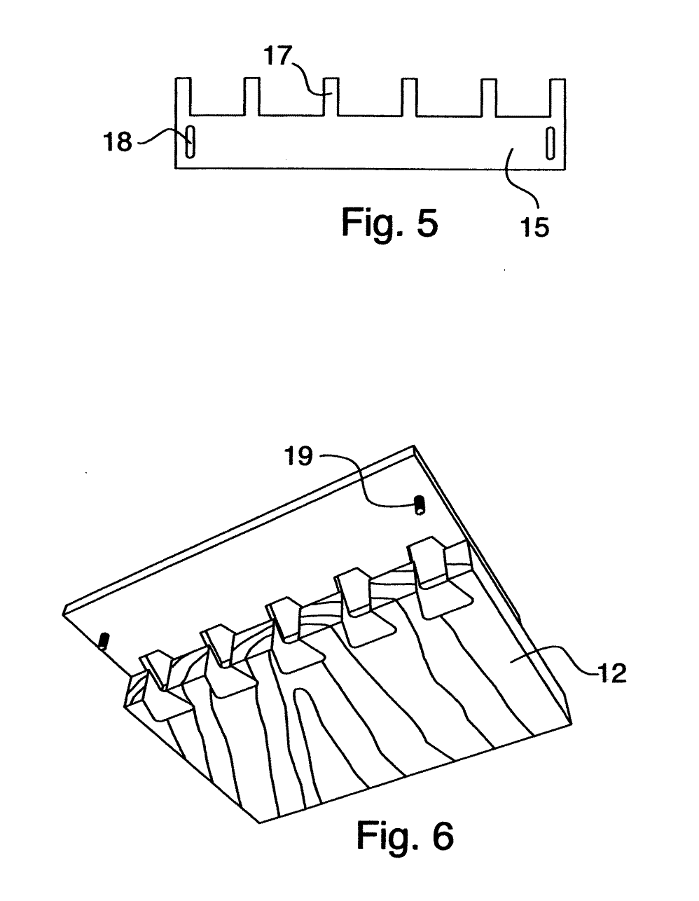

As can be understood from the brief description above, a through dovetail joint, as seen in FIG. 9b, can be easily cut using the present device with only a limited amount of adjustments. However, even though the above embodiment is all that is required for a skilled woodworker to produce accurate joints, to facilitate accurate adjustment for the hobbyists in another embodiment of the invention, a stopper 15, as seen in plan view in FIG. 5 is provided for the tail board template 1. The stopper 15 is also made of thin plate and has several rectangular areas defined by several fingers 17 extending from the main body, the spacing of the fingers corresponding to the areas between the cutouts in the template 1. Although a stopper of this construction can be easily used by a skilled craftsman by accurately measuring the position of the stopper 15 and clamping it to the tail board template 1, in a further embodiment of the stopper at least two generally rectangular openings 18 are provided extending parallel and adjacent to either edge of the stopper.

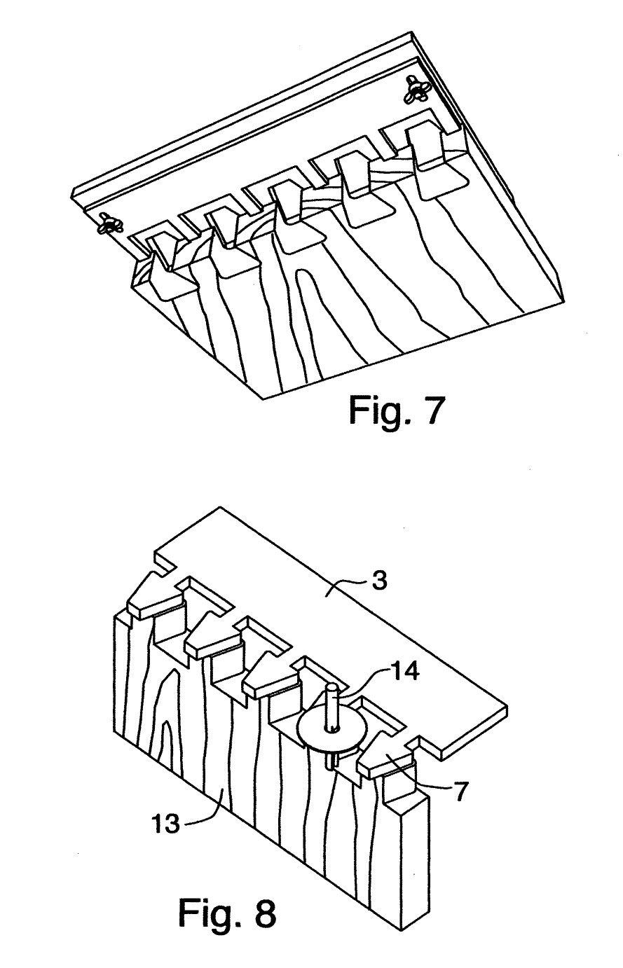

The operation of the stopper 15 will be explained in conjunction with FIGS. 6 and 7. Although this explanation relates to the further embodiment of the stopper 15, those skilled in the art can readily see that the principles are very similar, with the convenience of use only being enhanced by the provision of this embodiment. As can be seen in FIG. 6, threaded posts 19 are attached by any means such as spot welding or pressing to either side of the bottom of tail board template 1 in the area above the narrowest portions of the cutouts 5, at a position corresponding to openings 18 in stopper 15. Here, the workpiece 12 is to be placed on the template 1 at a position for cutting the tail board to an appropriate depth, that is the depth from the narrowest to the broadest portion of the cut as shown in the drawing, as shown here for exemplification. To facilitate setting the depth of this cut, the stopper is mounted to the template 1 so that posts 19 pass through the openings 18 to receive fasteners such as wingnuts. The stopper is then set in a position that equals the width of the workpiece 13 from the inner edge 13a to the outer edge 13b, i.e. the proper depth of the cut, by measuring the distance from the end of the fingers 17 to the narrow top of the cutouts 5, and firmly fixed in position by tightening the wingnuts shown here or other suitable means. The workpiece 12 is then butted up against the stopper 15 and clamped to the template 1, as shown in FIG. 7.

In this way, the depth of the tail board cut can be simply and accurately set to the width of the workpiece 13, i.e. the pin board. The board is then cut as in the first embodiment.

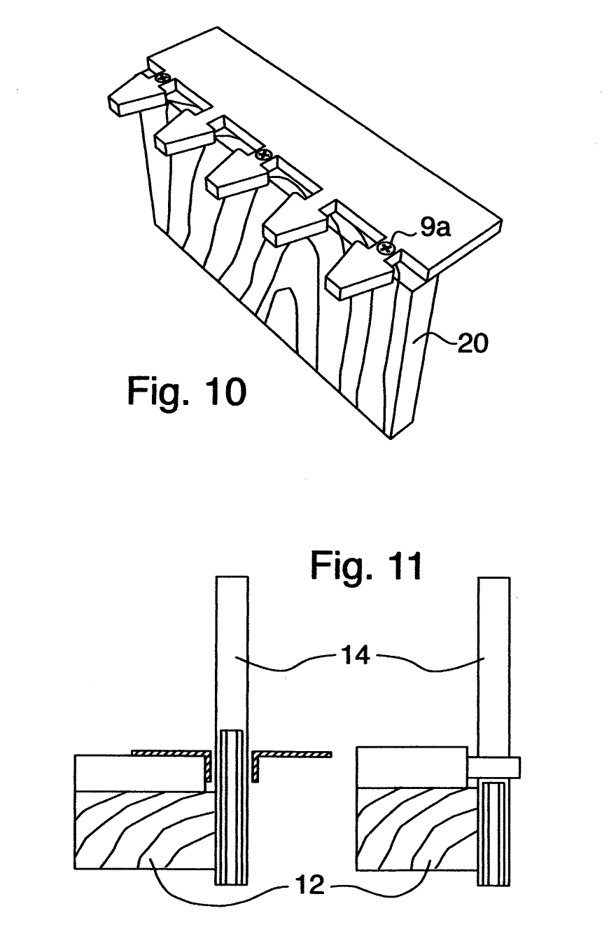

In a further embodiment of the invention as seen in FIG. 10, at least two through holes 9a are provided in the bridges 9 of pin board template 3. A backer board 20 using any flat piece of scrap wood, for example, can then be mounted to the template 3 by screws or the like at a position where the backing surface of the backer board 20 aligns with the bottom wide or broadest portions of the fingers 7. In this way, the pin board workpiece 13 can be appropriately clamped to the backer board 20 at a position ready for cutting the pins. The router is then used similarly to the method show in FIG. 8, except that the router will also cut into the backer board 20 while cutting the back portion of the pins. However, as this area will always be the same for the same template, the backer board can be used repeatedly with no problem without affecting the accuracy of the pin cuts.

Another advantage of the present device as mentioned above is the need to only use one router bit for all the cuts. Specifically, since the templates of the present device are made of a thin material such as metal or plastic, the only requirement for a router bit is the use of a template guide or pilot bearing to run along the edges of the fingers or cutouts of the templates. This is concretely shown in FIG. 11 where the use of a template guide 14a and pilot bearing 14b are both shown for reference. Most known template guides or pilot bearings have a bit surface depth of at least ¼ inch. This allows the cutting to be carried out without damaging the tail board or pin board templates when the templates are ¼ inch thick or less, and also allows them to be made of stiff materials other than metal such as plastic.

Also, as mentioned above, by first setting the router to cut just to the bottom of the tail board or workpiece 12, as seen in FIG. 11, the same setting can be used to cut the pin board, greatly facilitating the whole process of cutting a series of through dovetail joints.

Although the above embodiments allow a woodworker and hobbyist to make accurate dovetail joints repeatedly with very few adjustments, each of the templates are limited to one size, hence allowing only one size of joint to be cut for each template. Even though the templates are fairly inexpensive as they only require simple machining or casting work to produce, stocking a large number of templates of different sizes can be prohibitive to a hobbyist.

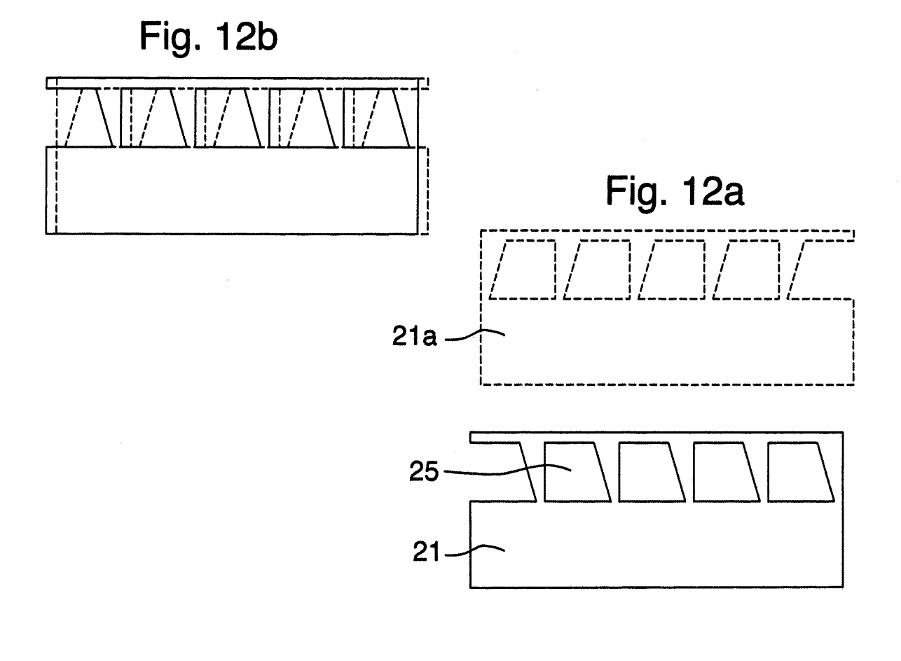

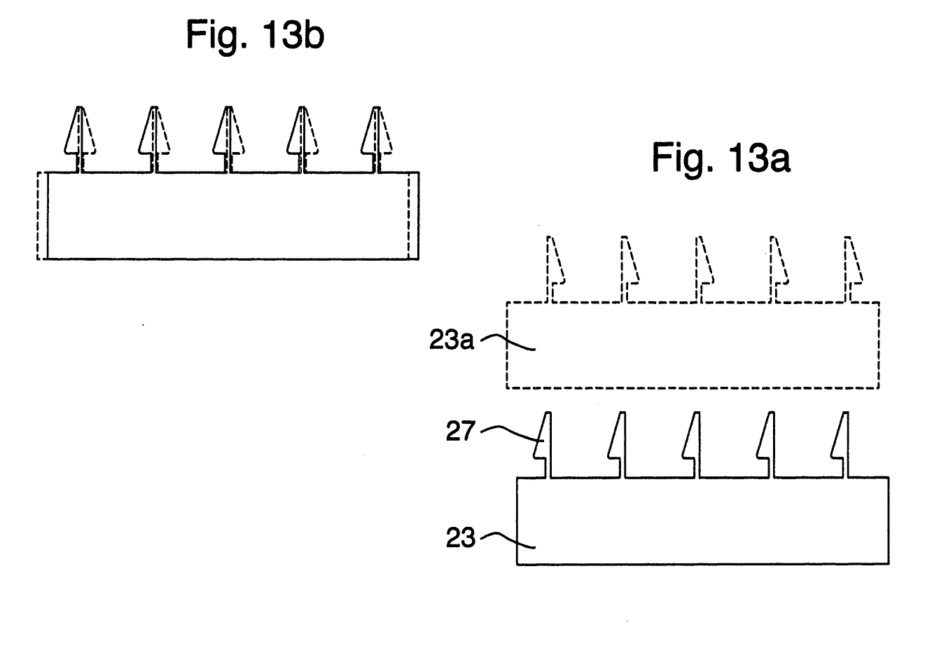

Accordingly, in another embodiment of the present invention, adjustable templates are provided, as shown in FIGS. 12a and 12b, and FIGS. 13a and 13b. These are essentially sets of thin plate-like members or mirror image templates that in combination can be used to vary the effective size of the cutouts or fingers. Specifically, as shown in FIG. 12a, tail board template 21 is provided with trapezoidal apertures or cutouts 25 that are similar to those in template 1, but differ in that they are not isosceles trapezoids, i.e. the two sides that are not parallel are not of equal length. The mirror image 21a of this template is essentially another of the templates 21 turned over so that the sides of the cutouts 25 not parallel to the sides of the template face in the opposite direction. Similarly, as shown in FIG. 13a, the pin board template 23 is provided with fingers 27 that are essentially one half of the fingers 7 of the first embodiment. The mirror image 23a of this template is also essentially another of the templates turned over so that the sail like portions of the fingers 27 point in the opposite direction.

With this embodiment, the pairs of respective mirror image templates are laid upon each other facing in reverse directions longitudinally, and slid back and forth until the desired size is reached, making the cuts smaller or wider. The templates can then be appropriately clamped to each other and used in the same fashion as in the above embodiments.

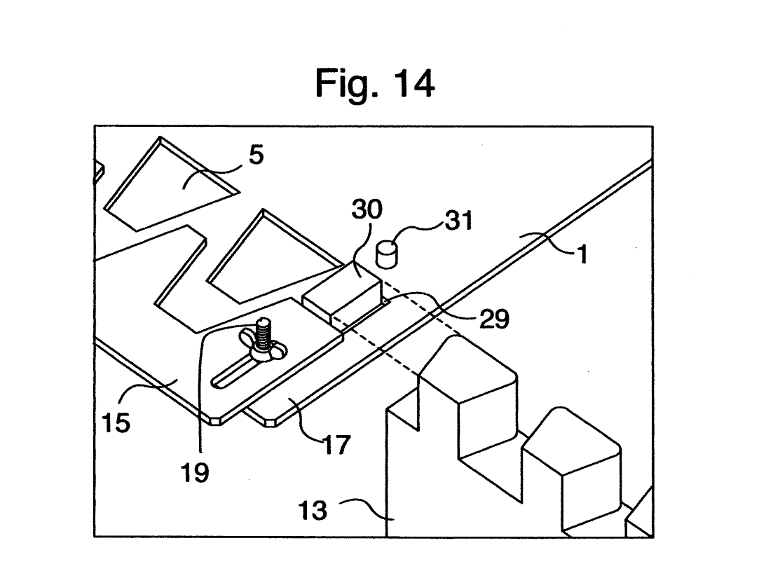

In a further embodiment of the invention, as seen in FIG. 14, the tail board template 1 is provided with a rectangular cutout or window 29 to either side of the series of cutouts 5, the top portion of the rectangular window 29 as seen in the figure being in parallel alignment with the bottom edge or broadest portions of the cutouts 5. A scrap piece 30 from the workpiece 13 is inserted in this cutout 29 and the stopper 15 is run up against the bottom edge of the scrap piece 30 and firmly secured to the template 1 as described above. As can be readily seen from the figure and as explained previously, by this simple provision the position of the stopper can be accurately set to the same width as the work piece 13, i.e. the pin board. As also seen in the figure, a set of guide pins 31 may also be provided above both of the windows 29. The guide pins are used to set the edge of the workpiece 12 in an appropriate position in relation to the farthest edges of the right and leftmost cutouts 5. As is readily apparent, this embodiment further simplifies the process described in relation to FIG. 7 of readying the template and workpiece for cutting the tailboard.

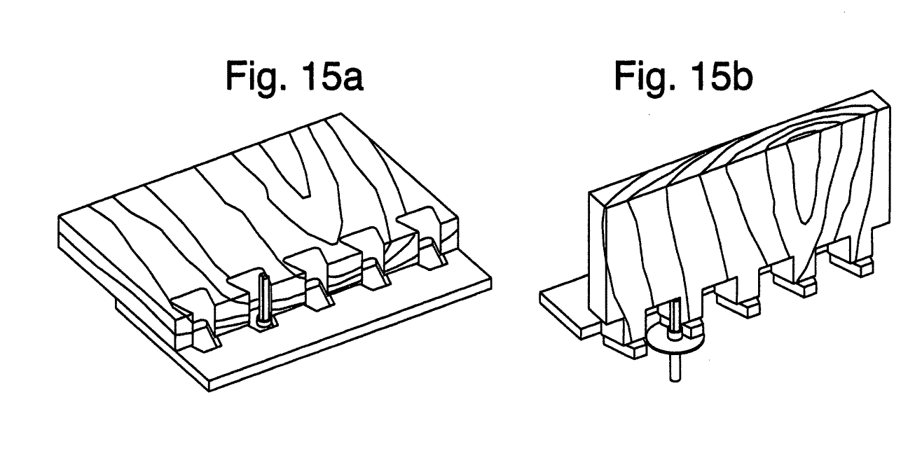

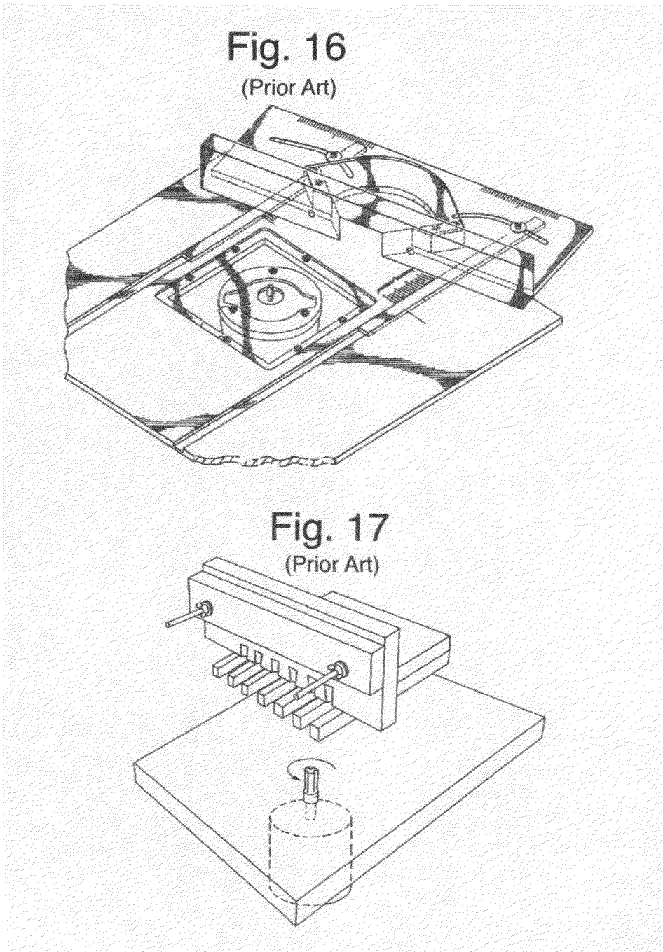

As mentioned above, the present device can be used with both hand held and table mounted routers. Examples of using table top routers for both the pin board and tail board are shown in FIG. 15a and FIG. 15b, where the templates are clamped to a workpiece and moved as a unit over the stationary router bit. Here, although the cutting of the pin board generally requires that the workpiece be vertical as seen in FIG. 15b, there is no such limitation on the tail board as readily discerned in FIG. 15a. Accordingly, even though the length of the pin board is limited by both the height of the ceiling or worktable in the workshop and the difficulty of moving the assembly over the table router, the tail board is not limited thereby and proper planning will allow projects with fairly long tail board pieces. This greatly expands the range of projects that can be carried out by the craftsman.

As can be seen from the above, the present guide device for cutting through dovetail joints greatly facilitates the process of cutting both tail boards and pin boards without the use of multiple fences, t-squares, numerous measurements, adjustments, etc. as in the conventional devices. The present invention also makes it possible to use a single router bit without any adjustments of router bit cutting depth, etc., outside of those needed to cut the workpiece easily, as the device does not depend on router bit cutting depth for accurate cuts. This allows reductions in both time spent making drawers, etc., and in the number of inaccuracies that are inherently introduced with conventional methods. It provides even hobbyist woodworkers with a tool that allows the cutting of dovetail joints that are crisp, accurate and flush, resulting in joints with a surprisingly professional appearance. The device is also very compact, comprising essentially two thin plate-like templates, with size being regulated only by the width of the joints to be produced, so that storage is much less of a problem than encountered by using conventional devices. Further, with use of the mirror image templates, only one device is needed for a variety of joint sizes, a versatility that can be appreciated by hobbyists with limited resources and/or space.

It is understood that various details of the invention may be changed without departing from the scope of the invention. Furthermore, the foregoing description is for the purpose of illustration only, and not for the purpose of limitation, the invention being defined by the claims.

What is claimed is:

1. A guide device for cutting a through dovetail joint comprising:
a tail board template comprising a thin plate-like member, the tail board template having a generally solid main body serving as a base with a series of equispaced isosceles trapezoidal cutouts provided longitudinally therein, narrowest portions of the cutouts in parallel alignment with a top edge of the tail board template opposite the base and broadest portions or bottoms of the cutouts in parallel alignment with a bottom edge of the main body;
a pin board template, comprising a thin plate-like member, the pin board template having a generally solid main body serving as a base with a series of equispaced isosceles trapezoidal fingers protruding in the same plane from the main body of the template, the fingers being connected thereto by relatively short rectangular connecting portions, the fingers being arranged so that narrow portions of the fingers delineate an upper edge of the template with broadest portions of the fingers being closest to the base, a series of open topped rectangular areas being formed between adjacent fingers by an upper edge of the main body, edges of the rectangular connecting portions and a line extending between the broadest portions of adjacent fingers.

2. A guide device according to claim 1 wherein a stopper is provided for the tail board template, the stopper comprising a thin plate-like ember, with a series of equispaced stopper fingers protruding therefrom, spacing of the stopper fingers generally corresponding to areas between the isosceles trapezoidal cutouts in the tail board template.

3. A guide device according to claim 2 wherein the tail board template is further provided with at least two rectangular windows, one on each side of the series of trapezoidal cutouts, a lowermost portion of each rectangular window being in parallel alignment with the broadest portions of the trapezoidal cutouts, the windows being adapted to accept a scrap piece from a workpiece, the stopper being firmly secured to the template 1 after being run up against the bottom edge of the scrap piece.

4. A guide device according to claim 2 wherein two threaded posts are attached adjacent to either edge of the main body of the tail board template in an area below the broadest portions of the trapezoidal cutouts, and the stopper is provided with two rectangular openings extending parallel and adjacent to either edge of the stopper, at a position corresponding to the threaded posts, the rectangular openings and threaded posts being used to fix the stopper to the tail board.

5. A guide device according to claim 4 wherein the tail board template is further provided with at least two rectangular windows, one on each side of the series of trapezoidal cutouts, a lowermost portion of each rectangular window being in parallel alignment with the broadest portions of the trapezoidal cutouts, the windows being adapted to accept a scrap piece from a workpiece, the stopper being firmly secured to the template 1 after being run up against the bottom edge of the scrap piece.

6. A guide device for cutting a through dovetail joint comprising:
a tail board template comprising two thin plate-like tail board template members, the thin plate-like tail board template members being essentially mirror images of each other, each member having a generally solid main body serving as a base with a series of equispaced trapezoidal cutouts provided longitudinally therein, narrowest portions of the cutouts in parallel alignment with a top edge of the tail board template opposite the base and broadest portions of the cutouts in parallel alignment with a bottom edge of the main body, the tail board template being adjustable so that the trapezoidal cutouts can form the general shape of an isosceles trapezoid when one of the two thin plate-like tail board template members is reversed and placed over the other thin plate-like tail board template member,
a pin board template comprising two thin plate-like pin board template members, the thin plate-like pin board template members being essentially mirror images of each other, each thin plate-like pin board template member having a generally solid main body serving as a base and a series of fingers in the general shape of a right triangle protruding from and in the same plane as the main body of the template, member, the fingers being arranged so that narrowest portions of the fingers delineate an upper edge of the template with broadest portions of the fingers being closest to the base, a series of open topped rectangular areas being formed between adjacent fingers by an upper edge of the main body, edges of the rectangular connecting portions and a line extending between the broadest portions of adjacent fingers, the pin board template being adjustable so that the fingers can form the general shape of an isosceles trapezoid when one of the two thin plate-like pin board template members is reversed and placed over the other thin plate-like pin board template member.

7. A guide device according to claim 6 wherein a stopper is provided for one thin plate-like tail board template member, the stopper comprising a thin plate-like member, with a series of equispaced stopper fingers protruding therefrom, spacing of the stopper fingers generally corresponding to areas between the isosceles trapezoidal cutouts in the tail board template.

8. A guide device according to claim 7 wherein two threaded posts are attached adjacent to either edge of the main body of the tail board template in an area below the broadest portions of the trapezoidal cutouts, and the stopper is provided with two rectangular openings extending parallel and adjacent to either edge of the stopper, at a position corresponding to the threaded posts, the threaded posts being fitted through the rectangular openings to fix the stopper to the tail board.

9. A guide device according to claim 8 wherein one of the plate-like tail board template members is further provided with at least two rectangular windows, one on each side of the series of trapezoidal cutouts, a lowermost portion of each rectangular window being in parallel alignment with the broadest edge of the trapezoidal cutouts, the windows being adapted to accept a scrap piece from a workpiece, the stopper being firmly secured to the template 1 after being run up against the bottom edge of the scrap piece.
